(19) United States
(12) Patent Application Publication
(10) Pub. No.: US 2002/0065839 A1
(43) Pub. Date: May 30, 2002

(54) Method and system for centrally organizing transactional information in a network environment

(76) Inventor: Darcy J. McCulloch, Scottsdale, AZ (US)

Correspondence Address: MORGAN LEWIS & BOCKIUS LLP, 1111 PENNSYLVANIA AVENUE NW, WASHINGTON, DC, 20004, US

(21) Appl. No.: 09/989,754

(22) Filed: Nov. 21, 2001

Related U.S. Application Data
(60) Provisional application No. 60/252,077, filed on Nov. 21, 2000.

(51) Int. Cl. G06F 12/00

(52) U.S. Cl. 707/200

(57) ABSTRACT

A computer-aided transaction processing method and system for documenting transactions conducted in a network environment. The system includes a first database for storing a user identifier and identity information for at least two users. An information processing system manages a transaction between the at least two users, wherein a transaction identifier is associated with the transaction. A second database stores a database record. The database record contains the transaction identifier, user identifiers of the at least two users involved in the transaction, and corresponding transactional data.

This application claims the benefit of a provisional application entitled “Method and System for Centrally Organizing Transactional Information in a Network Environment,” that was filed Nov. 21, 2000 and assigned Provisional Application Number 60/252,077, which is hereby incorporated by reference.

### BACKGROUND OF THE INVENTION

A. Field of the Invention

The present invention relates to a method and system for processing and storing transactional information, and more particularly, to a secure method and system for centrally organizing transactional information throughout the various stages of a transaction.

B. Discussion of the Prior Art

The expansion and availability of communication networks has affected the techniques and systems used for conducting two-party and multi-party transactions. Today, many consumer and business transactions are conducted in a network environment, disputed, and finally archived using a myriad of technologies including computer systems, communication networks, and databases.

A typical two-party or multi-party transaction usually progresses through a series of stages that together represent the lifecycle of the transaction. The lifecycle for a conventional two-party vendor/client transaction may include, for example, the following stages: Initiation (i.e., offer); bargaining; acceptance; delivery; and confirmation. Depending on the underlining transaction and the terms of the transaction as dictated by the parties, a transaction may involve any number of different stages. For example, an exemplary transaction involving credit may include an additional stage in which one or more parties seek and obtain credit approval from a third-party, such as a bank.

Some transaction processing methods and systems currently enable parties to conduct networked-based transactions in which at least a portion of the overall transaction utilizes one or more computer networks. For example, some online business-to-business (B2B) portals provide buyers and suppliers a venue to engage in online transactions. Moreover, some online retailers provide customers the opportunity to conduct online transactions using various payment methods.

However, current techniques for conducting and tracking online transactions have a number of shortcomings. First, utilizing proprietary systems, the transacting parties usually independently track and record on-going transactions. In other words, each party to the transaction, for example a buyer, seller, or creditor, independently monitors the progress of the transaction and independently records some or all of the transactional information. Because each transacting party may evaluate and weigh the relevancy of the transactional information differently, each party may record different information about the same transaction. The non-uniformity with respect to the terms, status, or progress of a transaction may delay or even impede the successful completion of a transaction. Furthermore, each party to the transaction usually records some or all of the transactional information locally, thereby resulting in information replication across multiple databases. The multiple versions of the same transactional information require additional hardware resources, thereby increasing costs.

There are also a number factors that contribute to miscommunication resulting in unnecessary expense and delay in transaction completion. Foremost among these factors is the synchronization of information. Any party may take unilateral action that affects the state of the transaction, but rarely is the state change rapidly communicated to the other parties. Therefore, yielding databases that are not “in synch” with each other. A second factor is that different methods for identifying and accessing transaction information are used by the parties. For instance, a seller may reference the transaction through an invoice number, a buyer through a purchase order number, and a financial institution through a record of charge number. This lack of a common identifier prolongs the resolution and increases the expense of exception items.

In light of the foregoing, there is a need for a method and system for tracking and recording network based transactions that efficiently facilitates the transaction between the parties and centrally records pertinent transactional information, thereby reducing hardware costs and increasing transparency with respect to the status of the transaction. Moreover, there is a need for an improved method and system for recording transactional information that enables the transacting parties to easily access and utilize the information.

### SUMMARY OF THE INVENTION

Accordingly, the present invention is directed to a method and system for centrally tracking and recording network-based transactions that substantially obviates one or more of the problems due to limitations and disadvantages of the related art.

One object of the present invention is to provide an efficient method and system for centrally organizing transactional information in a single database.

Another object of the present invention is to provide transactional parties an efficient and cost-effective method and system for tracking, storing and retrieving transactional information.

Yet another object of the present invention is to provide a method and system that automatically updates a single transaction database during the lifecycle of a transaction.

Another object of the present invention is to provide transacting parties relevant, timely, and uniform information regarding the status of a transaction.

Another object of the present invention is to provide a cost-effective and efficient system for tracking and recording the various stages of a transaction.

Additional objects and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, in one aspect of the present invention there is provided a computer-aided method for tracking and storing network-based transactional data. The method includes identifying each user by a user identifier; storing the user identifiers in a first database; associating a transaction identifier with a transaction between at least two users having user identifiers; storing the transaction identifier, the user identifiers of the at least two users involved in the transaction, and transactional data in a second database; providing at least some of the transactional data to at least two users of the transaction; and updating the transactional data.

In another aspect, the present invention provides a computer-aided transaction processing system for documenting transactions conducted in a network environment. The system includes a first database for storing a user identifier and identity information for at least two users; an information processing system for managing a transaction between the at least two users, wherein a transaction identifier is associated with the transaction; and a second database for storing a database record, wherein the database record contains the transaction identifier, user identifiers of the at least two users involved in the transaction, and corresponding transactional data.

In another aspect of the present invention there is provided a computer-aided transaction processing system having means for storing a user identifier and identity information for at least two users; means for managing transactional data associated with a transaction between the at least two users, wherein the transaction is identified by a unique transaction identifier; means for storing the transaction identifier, user identifiers of at least two users involved in the transaction, and corresponding transactional data; and means for enabling users involved in the transaction to access at least some of the transactional data.

In another aspect, there is provided a computer program product comprising computer readable program code for documenting transactions conducted in a network environment. The computer program product includes computer readable program code means for storing a user identifier and identity information for at least two users; computer readable program code means for managing transactional data associated with a transaction between the at least two users, wherein the transaction is identified by a unique transaction identifier; computer readable program code means for storing the transaction identifier, user identifiers of the at least two users involved in the transaction, and corresponding transactional data; and computer readable program code means for enabling users involved in the transaction to access at least some of the transactional data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 graphically depicts a typical account-based memory structure;

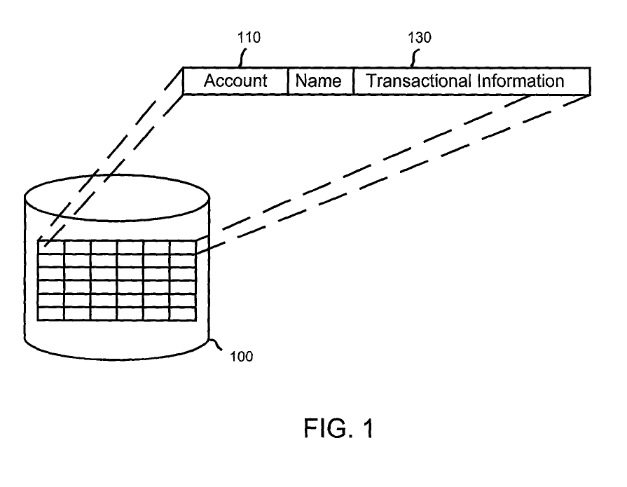

FIG. 2 is a block diagram showing an exemplary client/server environment;

FIG. 3 is a block diagram showing a system for organizing network-based transactional information according to an exemplary embodiment of the present invention;

FIG. 4 is a block diagram showing exemplary relationships between a buyer, seller, and one exemplary embodiment of the present invention;

FIG. 5 is a block diagram showing an exemplary network-based transaction between a buyer and a seller;

FIG. 6 is a block diagram showing an exemplary alternative implementation of the present invention;

FIG. 7 graphically depicts an exemplary memory structure of a profile database according to one exemplary embodiment of the present invention;

FIG. 8 is a block diagram showing exemplary transactions between various parties according to one exemplary embodiment of the present invention;

FIG. 9 graphically depicts an exemplary memory structure of a transaction database according to one exemplary embodiment of the present invention;

FIG. 10 graphically depicts the transacting parties access to information recorded in a transaction database according to one exemplary embodiment of the present invention;

FIG. 11 is a flow diagram showing a method for tracking and recording networked-based transactional information according to one exemplary embodiment of the present invention; and

FIG. 12 is a block diagram showing data flow in an exemplary transaction between a buyer and seller involving credit according to one exemplary embodiment of the present invention.

### DETAILED DESCRIPTION OF THE PREFERRED EMBODIMENTS

Certain terminology is used herein for convenience only and is not to be taken as a limitation on the present invention.

Reference will now be made in detail to the preferred embodiments of the present invention, examples of which are illustrated in the accompanying drawings. Wherever possible, the same reference numbers will be used throughout the drawings to refer to the same or like elements.

A. Introduction

The present invention provides a secure method and system for tracking and storing network-based transactional data. The transaction processing system uniquely identifies each transaction between the same or different parties. Information from each stage of the transaction, from initiation through to completion, is associated with a unique identifier and is stored in a single database record created and formatted for the particular transaction. During the life-cycle of the network-based transaction, the unique transaction identifier or another identifier associated therewith may be transmitted to relevant parties to the transaction, thereby enabling the parties to track and access the information. Information relevant to a particular user, such as purchase order number, order number, invoice number, or record of charge number that correlates to the unique identifier, may be used to access the transaction information contained in the database.

Since each transaction is uniquely identified, the fraudulent interception and replication of the transaction identifier does not comprise the transacting party's other transactions. Using the unique transaction identifier, the transaction processing system can provide each party access to a portion or all of the transactional information. Providing transacting parties or even authorized third parties with relevant and up-to-date information regarding the transaction encourages the efficient and timely completion of the transaction. Furthermore, storing relevant information from the various stages of the transaction in a single transaction database eliminates the need for each transacting party to maintain a separate system for tracking the transaction. Therefore, the parties do not incur costs associated with maintaining and operating separate computer and storage systems.

B. Network Environment

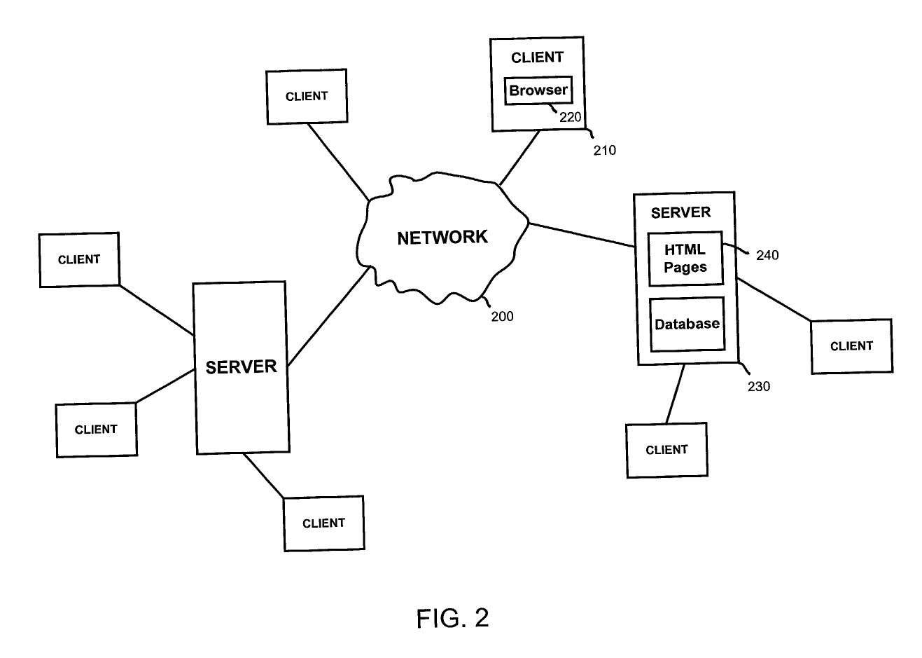

Preferably, the system of the present invention operates in a client/server environment, such as the Internet. FIG. 2 is a simplified illustration of an exemplary client-server environment, in which features of the present invention may be implemented. Namely, one component of the transaction processing system of the present invention may reside at a server 230 connected to the network 200. The server component of the present invention manages the transaction, maintains relevant databases, and communicates with the transaction parties via the network 200.

The parties may communicate with the transaction processing system using a client browser 220 running on a client system 210. In one embodiment, the user's browser may have a plug-in component for implementing the system of the present invention. Alternatively, one skilled in the art will appreciate that the method and system of the transaction processing system could be implemented in other software configurations or even without a client-based component. For example, instead of a plug-in for a browser, the parties component may consist of a stand alone application.

Communication among the parties and system of the present invention is preferably conducted using standard Internet protocols that are known in the art, including Hypertext Transfer Protocol (HTTP), File Transfer Protocol (FTP), and Secure Socket Layer (SSL). Alternatively, communication among the parties and/or systems may be conducted using a proprietary protocol, or a combination of standard and proprietary protocols.

For example, Web servers and clients, connected to the Internet 200, can communicate using HTTP. An exemplary Web server 230, receives HTTP requests from various client systems 210. Using a Web browser 220, such as Netscape Navigator™ or Internet Explorer™, the user requests to access Web pages 240 identified by a URL (Uniform Resource Locator). The Web server 240 responds to the request and/or other queries by providing the requested Web pages 240 to the client system 210. The pages are typically in the form of a text document coded in a standard language such as Hypertext Markup Language (HTML).

C. System Hardware

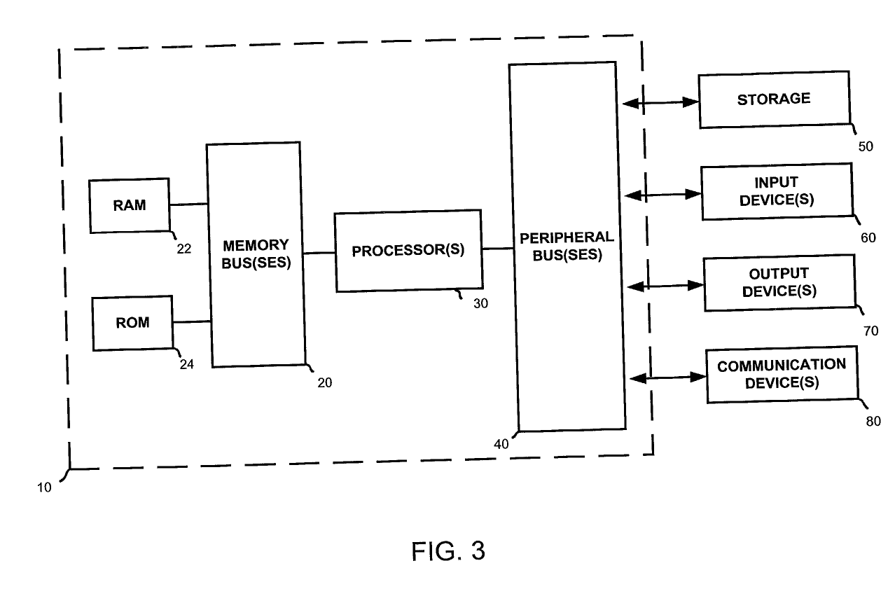

A computer system representing an exemplary server in which features of the present invention may be implemented will now be described with reference to FIG. 3. The computer system 10 comprises a processor 30, such as a microprocessor, a central processing unit (CPU), or parallel processor, memory bus 20, random access memory (RAM) 22, read only memory (ROM) 24, peripheral bus 40, external storage (e.g., hard disk drive or optical media) 50, and various input/output devices. For instance, the computer system 10 may also include one or more input devices 60 including, but not limited to, a keyboard, mouse or pointer, microphone, and scanner. Moreover, system 10 may include one or more output devices 70 including a display screen (or monitor) and printer.

The processor 30 may be a general purpose digital processor which controls the operation of the computer system 10. Using instructions retrieved from memory, the processor 30 controls the reception and manipulation of input data and the output and display of data on output devices 70.

Each of memory bus 20 and peripheral bus 40 may be formed of one or more busses of one or more types. The memory bus 20 is used by the processor 30 to access the RAM 22 and the ROM 24. The RAM 22 may be used by the processor 30 as a general storage area and as storage for input data and processed data. The ROM 24 may be used to store instructions or program code executed by the processor 30 as well as other data. The peripheral bus 40 is used to access the storage devices 50, input devices 60, and output devices 70 used by the computer system 10. The processor 30, together with an operating system, execute computer code and produce and use data.

The computer code and data may reside in RAM 22, ROM 24, in external storage 50, or even on another computer connected via a network or a combination of the foregoing. The computer code and data could also reside on a removable program medium and loaded or installed onto the computer system 10 when needed. Removable program mediums include, for example, CD-ROM, PC-CARD, floppy disk, magnetic tape, and optical media.

A communication device 80 is also coupled to bus 40 for connecting the server to one or more networks, such as the Internet. The communication device 80 may include a modem, a network interface card, or other commercially available network interface devices, such as those used for coupling to an Ethernet, token ring, or other type of network. Using communication device 80, computer system 10 may be coupled to a number of clients and/or other servers via a conventional network infrastructure, such as a company's Intranet and/or the Internet, for example.

Implementation of the present invention is not limited to the specific hardware configuration shown in FIG. 3. Instead, those skilled in the art will appreciate that the method and system of the present invention may be advantageously implemented using a variety of computer systems such as mainframe and Web-based platforms.

D. System Software

The software of the present invention implemented on computer system 10 may be written in any suitable computer language. In the present embodiment, the software is written using the C++ programming language.

E. General Overview

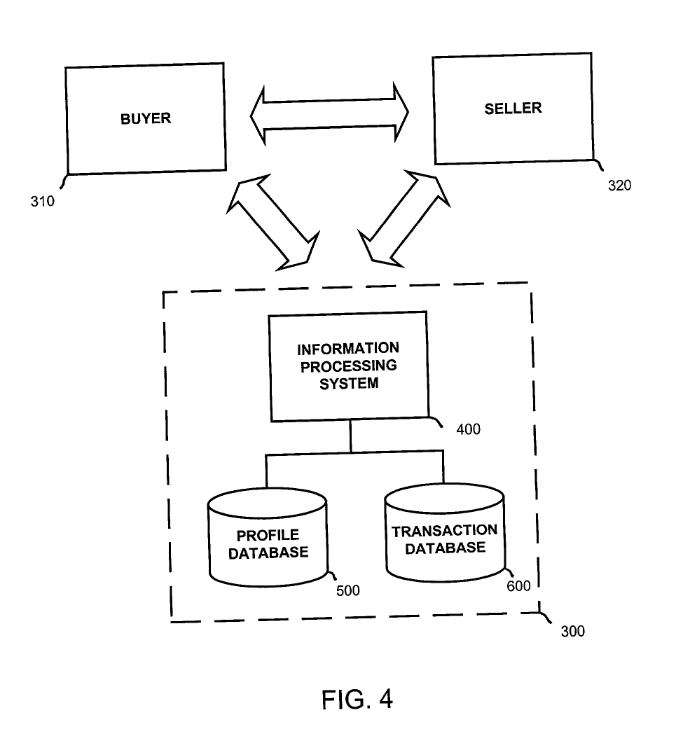

FIG. 4 shows an overview of the interactions in an exemplary buyer/seller transaction implementing one exemplary embodiment of the present invention. The present embodiment of the transaction-documenting system 300, which includes an Information Processing System 400, a Profile Database 500, and a Transaction Database 600, may be implemented in any number of scenarios including, but not limited to, business-to-consumer (B2C) and business-to-business (B2B) transactions. As shown in FIG. 4, the system of the present invention is not necessarily the exclusive communications channel between the buyer 310 and seller 320. Depending on the type of transaction and the parties involved, the system of the present invention may or may not provide the sole communications means between the parties.

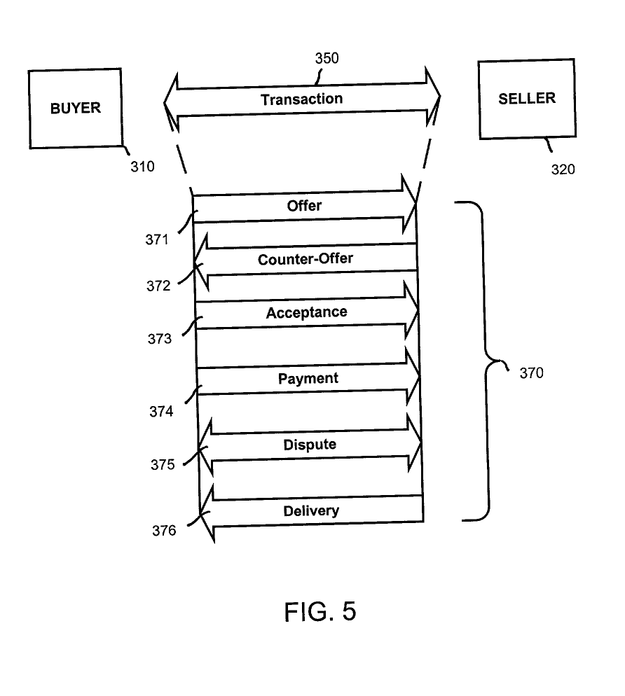

Typically, a complete B2C or B2B transaction—from initiation to delivery and payment—constitutes a number of discrete steps or stages. The number of stages and the particular function or purpose of each stage may depend on a number of variables including, but not limited to, the type of transaction (e.g., real estate, sale of goods), the number of parties, disputes, and third-party financing. For example, the exemplary transaction 350 between a buyer 310 and seller 320 graphically depicted in FIG. 5 contains the following stages 370: An offer 371 by the buyer 310; a counter-offer 372 by the seller 320; acceptance 373 of the terms; payment 374 by the buyer 310; a dispute 375 between the parties; and delivery 376 of the product.

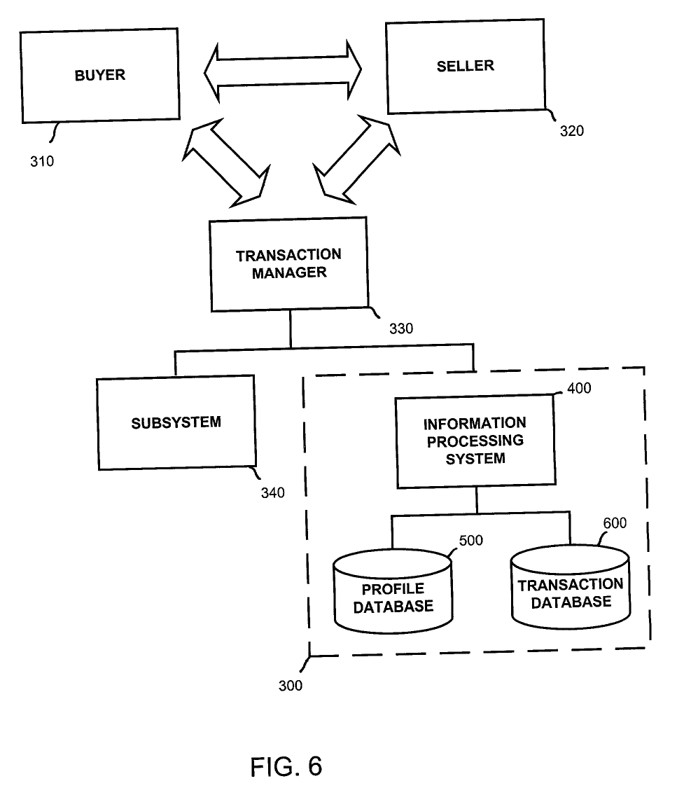

The system of the present invention may be implemented in any number of manners. For example, using techniques known in the art, the Information Processing System 400, among other tasks, may manage the flow of information during the transaction, transmit and receive network messages, process information regarding the parties and the transaction, and maintain the Profile Database 500 and Transaction Database 600. In an exemplary alternative embodiment shown in FIG. 6, the system of the present invention may be implemented as an integrated subsystem 340 of a transaction manager 330 that controls the transaction. Alternatively, as one skilled in the art will appreciate, the functions of information processing system 600 may be integrated into the operation of a transaction manager 330. FIGS. 4 and 6 present exemplary embodiments of the present invention in the context of a two-party transaction. Alternatively, the system of the present invention may be implemented in a multi-party transaction.

The transacting parties may be granted access to some or all of the information recorded in Transaction Database 600 shown in FIGS. 4 and 6. As one skilled in the art will appreciate, the level of access each party is given to the centrally stored information can be varied. Moreover, each party to the transaction may have more than one authorized participant (i.e., user). For example, an employer may grant certain employees authority to transact on behalf of the company. Therefore, multiple sub-purchasers may represent an employer in a so-called two-party transaction. Even if a sub-party is acting on behalf of a party, all relevant information is identified and recorded in the Transaction Database 600 according to the transaction identifier.

Unlike a conventional two-party or multi-party transaction where each party maintains separate databases with possibly different transactional information, the present embodiment utilizes a single Transaction Database 600 for recording the status of the transaction as it progresses. Furthermore, the buyer 310 and seller 320 each have access to some or all of the content of the Transaction Database 600. Therefore, uniform and relevant information regarding the transaction can be efficiently provided to both the buyer 310 and seller 320, for example.

F. Information Processing System

The Information Processing System 400, according to one exemplary embodiment of the present invention, manages the storage and retrieval of information in a Profile Database 500 and Transaction Database 600. In other words, The Information Processing System 400 may create records in the Profile Database 500 and Transaction Database 600, associate transaction identifiers with each transaction, record and retrieve information from each database, and control access to the content of each database. Other operations and functions of the Information Processing System will be discussed below in reference to the Profile Database 500 and Transaction Database 600.

G. Profile Database

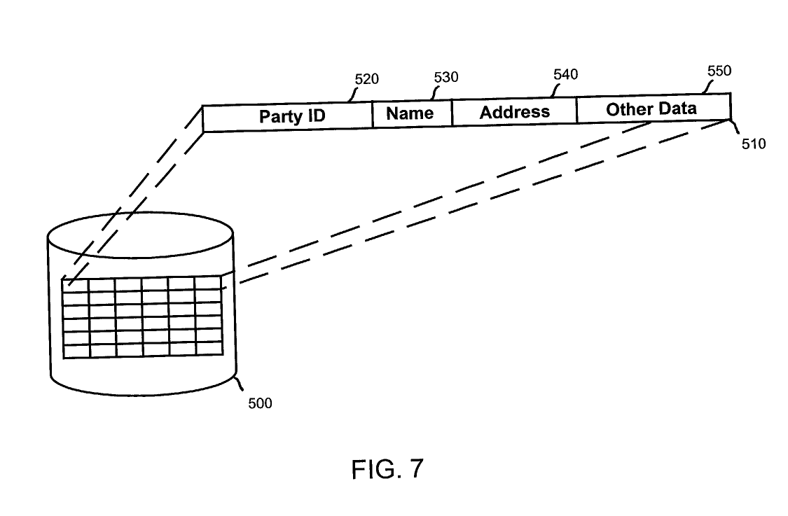

FIG. 7 shows an exemplary record of a Profile Database 500 according to one embodiment of the present database. Each party, including buyers, sellers, companies, and banks, who wish to implement the system of the present invention establishes a profile 510 that is stored in one or more Profile Databases 500. In one embodiment of the present invention, the profile 510 may contain a Party Identifier 520 and traditional account information, such as the party's name 530, address 540, and other data 550 such as telephone address, and primary contact information. The unique Party Identifier 520 may be created and formatted using techniques or conventions known in the art. After the primary contact for a party has established a profile 510, then one or more additional profiles 510 may be created for each employee authorized to transact on behalf of the primary contact.

Besides the unique Party Identifier 520 and basic account information, the profile 510 may also contain other data 550, for example, the party's access rights to different transactional information and system operations. Again, the information stored in the profile 510 associated with a particular party may vary depending on a number of factors including, but not limited to, the type of party (i.e., consumer, business, or bank), the number of sub-parties, and the type of transaction.

In a B2C environment, which typically involves a bank, a consumer, and a business, preferably, three primary profiles 510 are created. Besides the traditional identification and contact information, the bank profile 510 may include individual employee profiles 510 with access rights information. The buyer's profile 510 may includes the buyer's name, address, and bank account information. Finally, the company's or seller's profile 510 may contain employee information and any associated access rights.

In an alternative exemplary embodiment involving a B2B transaction, the profile 510 for each business may include the company's name, address, telephone number, federal tax ID, and primary contact information. As one skilled in the art will appreciate, the type of information stored in a profile 510 is not limited to the basic profiles 510 described above. Furthermore, the profile 510, which contains a unique Party Identifier 520 and traditional account information, may be recorded in more than one Profile Database 500.

H. Transaction Database

Unlike conventional transactions conducted between two or more parties in a network environment, the system of the present invention records the data associated with a transaction in a single Transaction Database 600. Until the parties agree that the transaction is complete, the transaction continues and the centrally stored transactional data may be updated. Furthermore, each party to the transaction may retrieve and view portions or all of the transactional information. Centrally storing the transactional data, such as the current status of a transaction, the earlier stages of the transaction, and possible disputes between the parties, has a number of benefits.

First, centrally storing transactional information between two adverse parties reduces costs because the information is not replicated in numerous databases across each party's computer system. The system of the present invention reduces the hardware and information processing costs associated with the duplication and redundant storage of transactional information—regardless of the data storage means and information processing techniques practiced by a transacting party.

Second, centrally storing relevant transactional information provides parties to the transaction uniform, unbiased information regarding the transaction. In a conventional transaction, each party may perceive the same transaction differently or may deem certain information irrelevant, thereby resulting in each party recording different information about the same transaction. Further hindering the progress of a transaction is the scenario in which a party fails to properly or timely record relevant transactional information.

For example, one party to a particular transaction may have made a counter-offer consisting of a price and quantity of a certain product. The adverse party may have failed to record the price or may have improperly recorded the price of the counter-offer. In subsequent negotiations, the lack of uniform information regarding previous negotiations may delay or even impede the successful completion of the transaction. Therefore, centrally documenting the status and progress of a transaction provides all parties timely, unbiased, and uniform transactional information that may facilitate the transaction.

In the present embodiment, all the transactional information is centrally stored in a transaction-based memory structure rather than an account-based structure. Each stage or event of the life-cycle of a distinct transaction is stored in the same database record. Therefore, the system of the present invention compartmentalizes transactional data according to a transaction identifier, thereby increasing the security of sensitive information.

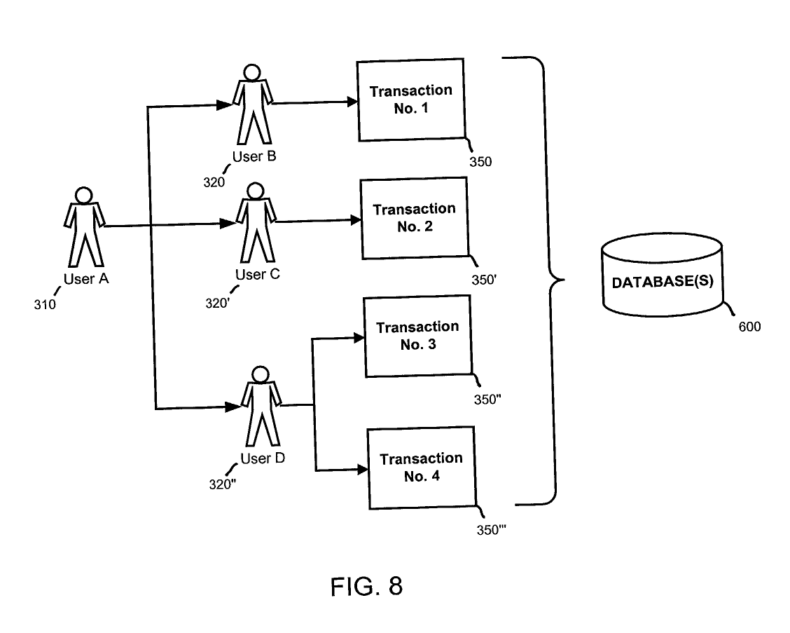

For example, FIG. 8 shows exemplary transactions between various users. User A 310 is shown transacting with User B 320 and User C 320′. Instead of recording Transaction No. 1 (350) and Transaction No. 2 (350′) in an account associated with User A 310, the transactional information is stored in separate records in one or more Transaction Databases 600. Likewise, the two transactions between User A 310 and User D 320″ (i.e., Transaction No. 3 (350″) and Transaction No. 4 (350″′)) are separately tracked and stored.

In contrast, conventional transactional systems record transactional information according to a party's account. To track and update a particular transaction, the party's account information must be transmitted across often insecure networks. The fraudulent interception of the party's account information could compromise all transactional information stored in the party's account.

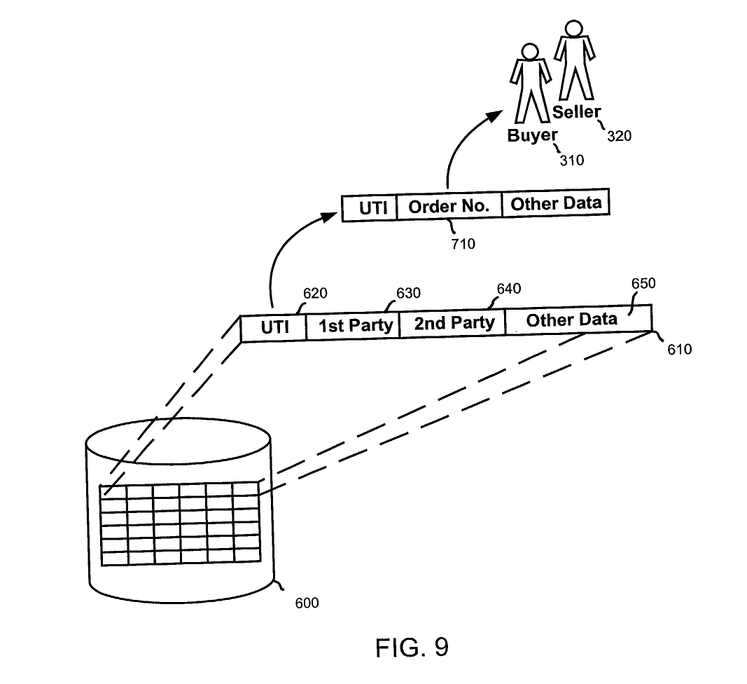

In one embodiment of the present invention, information from the various stages of a transaction is stored in a single record 610 of a Transaction Database 600 as shown in FIG. 9. Each transaction is identified and tracked according to a Unique Transaction Identifier (UTI) 620. For example, when a buyer 310 and seller 320 enter into a transaction, a record 610 is created in a Transaction Database 600 and a Unique Transaction Identifier 620 is stored in the record 610 along with other transactional information 650. Each party may use a surrogate identifier, such as purchase order number or invoice number, that directly correlates to the Unique Transaction Identifier to access the Transaction Database.

Using the Unique Transaction Identifier 620, the Information Processing System 400 stores and retrieves records 610 from the Transaction Database 600. Besides a Unique Transaction Identifier 620, each record 610 in the Transaction Database 600 may include information for identifying the parties to the transaction. For example, FIG. 9 shows exemplary fields labeled “1^{st} Party” 630 and “2^{nd} Party” 640 for identifying the transacting parties.

Using the Unique Transaction Identifier 620, the buyer 310 and seller 320 may retrieve and view information from the Transaction Database 600. Alternatively, the Unique Transaction Identifier 620 may be associated with a surrogate identifier, such as a purchase order number 710 or invoice number that the parties may use to retrieve transactional information.

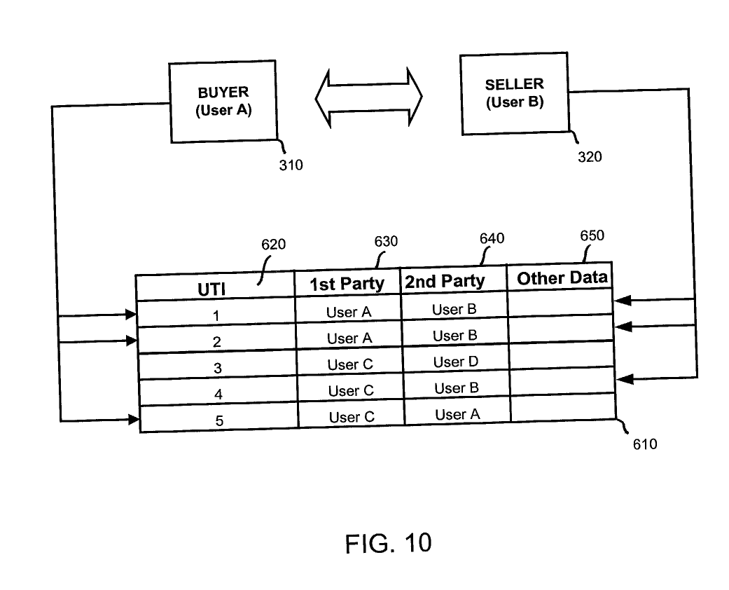

As shown graphically in an exemplary embodiment in FIG. 10, buyer 310 may access information from those records 610 of the Transaction Database 600 in which buyer 310 is listed as one of the parties. Since buyer 310 is recorded as a transacting party in the 1^{st}, 2^{nd}, and 5^{th} transactions shown in the exemplary memory structure in FIG. 10, buyer 310 may have access to at least some of the information recorded in each of the corresponding records 610. FIG. 10 also shows that buyer 310 and seller 320 are involved in two mutual transactions.

The record 610 for each transaction include fields for the Unique Transaction Identifier 620, a first Party Identifier 630, and a second Party Identifier 640. Preferably, the record 610 also contains other transactional data 650. As one skilled in the art will appreciate, the type and amount of other transactional data 650 stored in the record 610 may vary depending on the transaction. As a particular transaction progresses through various stages (e.g. negotiation, offers, and counter-offers), the system of the present invention automatically updates the record 610 that corresponds to the particular transaction.

I. Exemplary Method

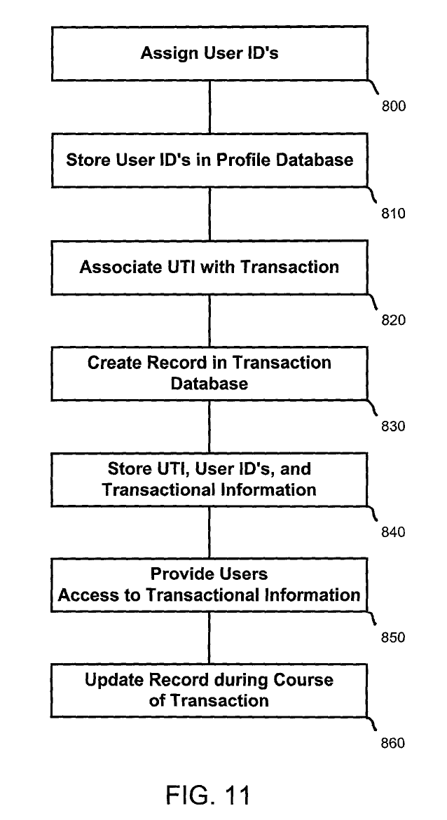

FIG. 11 shows a flow diagram of a method for implementing one embodiment of the present invention. At step 800, each user is assigned a unique Party Identifier 520 or identification number. At step 810 the Party Identifiers 520 are stored in one or more Profile Databases 500. As discussed earlier, traditional account information, such as the company's name, address, and other contact information may be stored along with the Party Identifier 520 in Profile Database 500.

When at least two authenticated users, for example User A and User B, enter into a transaction, the Information Processing System 400 at step 820 associates a Unique Transaction Identifier 620 with the distinct transaction. In one embodiment of the present invention, the Unique Transaction Identifier 620 is internally used throughout the lifecycle of the transaction to identify the transaction between the parties. If the same parties, for example User A and User B, enter into a concurrent or subsequent transaction, then another Unique Transaction Identifier 620 would be created and associated with the second transaction between the same parties.

Taking the anticipated transaction stages into consideration at step 830, the Information Processing System 400 creates a record 610 in Transaction Database 600. The record 610 is preferably formatted to account for the various stages and contingencies that may occur during the life-cycle of the transaction. For example, a record 610 for a conventional two-party buyer/seller transaction may include fields for a purchase amount, a credit card number, and delivery date, as well as fields for contingencies involving payment and delivery disputes.

Then at step 840, the Unique Transaction Identifier 620, the Party Identifiers 520, and all relevant transactional information is centrally stored in a single relational record 610 of the Transaction Database 600. Using the Unique Transaction Identifier 620 to identify the transaction, the users at step 850 may access some or all of the centrally stored transactional information. In an alternative embodiment, an order number 710 instead of the Unique Transaction Identifier 620 may be transmitted to each party. As one skilled in the art will appreciate, other identifiers may be associated with the Unique Transaction Identifier 620 and distributed to each authorized party or authorized third party. Using the Unique Transaction Identifier 620 or surrogate identifier, such as an order number 710, the user may access the transactional information, preferably, through a Web interface. Therefore, each user may independently retrieve recorded transactional information for purposes of checking the status of a transaction and determining the next action to be taken by the user in the transaction.

During the course of the transaction, the database record 610 corresponding to the Unique Transaction Identifier 620 may be automatically and timely updated at step 860 with current transactional information. Although the database record 610 may be updated at any time during the transaction, preferably, timely and current transactional information is stored after each stage of the transaction and when any timed-events occur. For example, if a user in a network-based transaction accepts an offer to sell an item according to the conditions conveyed to the user, then the acceptance and conditions thereto are timely recorded in the centrally stored database record 610. Furthermore, if the offer to sell depends on the buyer's credit approval within a certain amount of time, then the failure of receiving such credit approval within the designated time-period may be timely recorded in the database record 610.

Depending on the context in which the system of the present invention is implemented, an Information Processing System 400 that manages and tracks a transaction may utilize the storage resources in a number of different manners. For example, a Information Processing System 400 may update the database record 610 in real-time or may only record relevant information after the completion of a particular stage of the transaction. Regardless of the timing of the update or the type and quantity of information recorded, the method and system of the present invention enables the central storage and retrieval of transactional information during the life cycle of a distinct transaction.

J. Exemplary Transaction

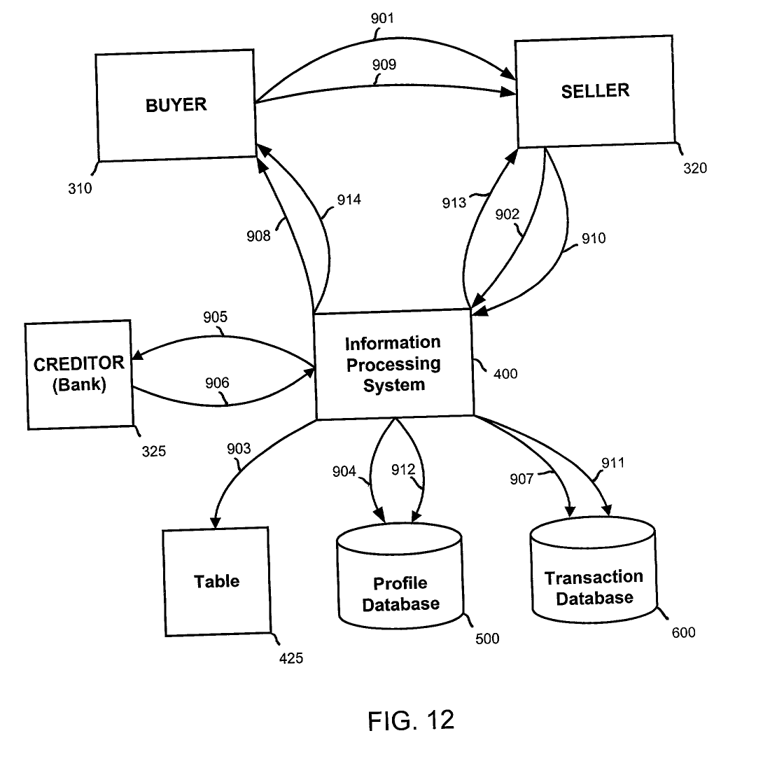

FIG. 12 shows an exemplary network-based transaction involving credit that utilizes the teachings of the present invention to centrally organize the information pertaining to the transaction. The buyer 310 may initiate 901 the transaction, for example, at a Web site operated by the seller 320. Assuming that both the buyer 310 and seller 320 have previously established profiles according to the teachings of the present invention, the seller 320 (i.e., seller's Web server) transmits 902 a message to the Information Processing System 400 running on one or more servers. The message may contain the buyer's encrypted Party Identifier and purchase information, such as a product identifier and purchase amount.

The Information Processing System 400 receives and processes the message. To authenticate the buyer 310, the system decrypts the buyer's identifier 520 and retrieves 903 the buyer's profile number from an identification table 425. Using the profile number, the system then retrieves 904 the buyer's 310 profile 510 from Profile Database 500.

Using the buyer's 310 account information stored in the profile 510, the system prepares and transmits 905 a payment authorization request to the third party creditor 325. The creditor processes the request. If the buyer 310 has sufficient funds, for example, the creditor's server transmits 906 a message to the Information Processing System 400 approving the transaction. The system then creates 907 a record in the Transaction Database 600 and associates a Unique Transaction Identifier with the transaction.

The system notifies 908 the buyer 310 that the purchase has been approved and transmits the Unique Transaction Identifier (or a corresponding identifier) to the buyer's 310 client system. A plug-in installed in the buyer's browser then transmits 909 the identifier and other information (e.g., the approval code of the transaction and shipping information) to the seller 320.

After receiving and processing the payment information, the seller 320 transmits 910 the completed transaction to the Information Processing System 400. The information transmitted may include, but is not limited to, the identifier, a product identifier, and transaction amount. Using the identifier, the Information Processing System 400 updates 911 the transactional information in the corresponding record of the Transaction Database 600. The system may also update 912 the buyer's and seller's profiles stored in Profile Database 500.

Finally, the system sends 913 a confirmation that includes the identifier to the seller 320 and notifies 914 the buyer 310 of any order information and order number previously provided by the seller 320. The above-described scenario only represents one exemplary transaction. One skilled in the art will appreciate that the method and system of the present invention may be implemented for any type of network-based transaction involving any number of stages.

It will be apparent to those skilled in the art that various modifications and variations can be made in the method and system for centrally locating transactional information in a network environment without departing from the spirit or scope of the invention. Thus, it is intended that the present invention cover the modifications and variations of this invention provided they come within the scope of the appended claims and their equivalents.

What is claimed:

1. A computer-aided method for tracking and storing network-based transactional data, the method comprising:
(a) identifying each user by a user identifier;
(b) storing the user identifiers in a first database;
(c) associating a transaction identifier with a transaction between at least two users having user identifiers;
(d) storing the transaction identifier, the user identifiers of the at least two users involved in the transaction, and transactional data in a second database;
(e) providing at least some of the transactional data to the at least two users of the transaction; and
(f) updating the transactional data.

2. The method of claim 1, wherein each user identifier is unique.

3. The method of claim 1, wherein the user includes a primary user having one or more sub-users.

4. The method of claim 1, wherein storing the user identifiers in the first database further comprises storing one or more user identity information in the first database.

5. The method of claim 4, wherein the user identifiers and the one or more identity information are stored in the same database record.

6. The method of claim 1, wherein each transaction identifier is unique.

7. The method of claim 1, further comprising providing the transaction identifier to the users involved in the transaction.

8. The method of claim 1, further comprising associating at least one surrogate identifier with the transaction identifier and providing the at least one surrogate identifier to the at least two users involved in the transaction.

9. The method of claim 1, wherein the transaction between the at least two users is distinct.

10. The method of claim 1, wherein the transaction between the at least two users includes transactions having one or more stages.

11. The method of claim 1, wherein the transaction between the at least two users is conducted in a network environment.

12. The method of claim 1, wherein the transactional data includes data from one or more stages of the transaction.

13. The method of claim 1, wherein the transactional data includes information about the status of the transaction.

14. The method of claim 1, wherein storing the transaction identifier, the user identifiers of the users involved in the transaction, and transactional data in the second database includes creating a transaction record in the second database and formatting the transaction record according to the characteristics of the transaction.

15. The method of claim 14, wherein the characteristics of the transaction include anticipated stages of the transaction.

16. The method of claim 1, wherein providing at least some of the transactional data to the at least two users involved in the transaction includes providing the users access to the transactional data in a network environment.

17. The method of claim 16, wherein providing the transactional data in the network environment includes enabling the users to access the transactional data at a Web site.

18. The method of claim 1, wherein providing at least some of the transactional data to the at least two users involved in the transaction includes providing the transaction identifier to the users and enabling the users to access at least some of the transactional data using the transaction identifier.

19. The method of claim 18, wherein enabling the users to access at least some of the transactional data using the transaction identifier includes enabling the users to access the transactional data in a network environment.

20. The method of claim 1, wherein providing at least some of the transactional data to the at least two users involved in the transaction includes associating at least one surrogate identifier with the transaction identifier and providing the at least one surrogate identifier to the users, and enabling the users to access at least some of the transactional data using the at least one surrogate transaction identifier.

21. The method of claim 20, wherein enabling the at least two users involved in the transaction to access at least some of the transactional data using the at least one surrogate transaction identifier includes enabling the users to access the transactional data in a network environment.

22. The method of claim 1, wherein updating the transactional data includes updating the transactional data during the course of the transaction.

23. The method of claim 1, wherein updating the transactional data includes storing additional transactional data and changing current transactional data, whereby previously written data is retained.

24. A computer-aided transaction processing system for documenting transactions conducted in a network environment, the system comprising:
a first database for storing a user identifier and identity information for at least two users;
an information processing system for managing a transaction between the at least two users, wherein a transaction identifier is associated with the transaction; and
a second database for storing a database record, wherein the database record contains the transaction identifier, user identifiers of the at least two users involved in the transaction, and corresponding transactional data.

25. The system of claim 24, wherein each user identifier is unique.

26. The system of claim 24, wherein the user includes a primary user having one or more sub-users.

27. The system of claim 24, wherein the transaction identifier is unique.

28. The system of claim 24, wherein the transactional data includes data from one or more stages of the transaction.

29. The system of claim 24, wherein the database record in the second database is formatted according to the characteristics of the transaction.

30. The system of claim 29, wherein the characteristics of the transaction include anticipated stages of the transaction.

31. The system of claim 24, wherein the database record is updated during the course of the transaction.

32. The system of claim 31, wherein the database record is updated by storing additional transactional data, changing transactional data, and voiding transactional data.

33. The system of claim 24, wherein the at least two users are provided access to at least some of the transactional data stored in the database record.

34. A computer-aided transaction processing system for documenting transactions conducted in a network environment, the system comprising:
means for storing a user identifier and identity information for at least two users;
means for managing transactional data associated with a transaction between the at least two users, wherein the transaction is identified by a unique transaction identifier;
means for storing the transaction identifier, user identifiers of at least two users involved in the transaction, and corresponding transactional data; and
means for enabling users involved in the transaction to access at least some of the transactional data.

35. The system of claim 34, wherein the means for managing transactional data associated with the transaction between the at least two users includes means for updating the transactional data.

36. A computer program product comprising computer readable program code for documenting transactions conducted in a network environment, comprising:
computer readable program code means for storing a user identifier and identity information for at least two users;
computer readable program code means for managing transactional data associated with a transaction between the at least two users, wherein the transaction is identified by a unique transaction identifier;
computer readable program code means for storing the transaction identifier, user identifiers of the at least two users involved in the transaction, and corresponding transactional data; and
computer readable program code means for enabling users involved in the transaction to access at least some of the transactional data.

37. The system of claim 36, wherein the computer readable program code means for managing transactional data associated with the transaction between the at least two users includes computer readable program code means for updating the transactional data.
